(19) United States
(12) Patent Application Publication
(10) Pub. No.: US 2006/0127784 A1
(43) Pub. Date: Jun. 15, 2006

(54) Producing partially translucent packaging materials

(75) Inventors: Detlef Schulze-Hagenest, Molfsee (DE); Dinesh Tyagi, Fairport, NY (US); Udo Draeger, Speyer (DE)

Correspondence Address: Paul A. Leipold;Eastman Kodak Company, Patent Legal Staff, 343 State Street, Rochester, NY, 14650-2201, US

(73) Assignee: Eastman Kodak Company

(21) Appl. No.: 11/351,721

(22) Filed: Feb. 9, 2006

(30) Foreign Application Priority Data
Aug. 12, 2004 (WO) PCT/US04/26181
Aug. 13, 2003 (DE) 10337159.1

(51) Int. Cl. G03G 9/08; G03G 15/06

(52) U.S. Cl. 430/97; 430/108.1

(57) ABSTRACT

Producing at least partially translucent packaging materials that contain natural dyes or pseudo-natural dyes, chlorophyll in particular. Natural dyes or pseudo-natural dyes are added to a toner and are applied to the packaging material in a printing step, preferably in an electrophotographic printing machine.

### FIELD OF THE INVENTION

The subject invention pertains to a process and toner for producing packaging materials that are at least partially translucent, preferably for use with foodstuffs, cosmetics, and pharmaceuticals, or other light sensitive products, and products that contain natural dyes and/or pseudo-natural dyes, particularly, chlorophyll.

### BACKGROUND OF THE INVENTION

Dyes, particularly chlorophyll dyes, are usually present in foodstuffs, cosmetics, and pharmaceuticals. When in the presence of light, they absorb certain wavelengths therefrom. The quality of these products can be adversely affected by such light absorption, particularly in connection with carbon dioxide. As a consequence, in practice, such products are frequently packaged in opaque packaging materials. However, there is also a need to examine the products, for example, to make quality determinations.

Consequently, in the German Patent Application DE 100 05 783 A1, it is proposed that the same natural dyes that absorb adverse light in the products, or instead, pseudo-natural dyes that are essentially identical to the natural dyes, be incorporated into the packaging materials, whereby the packaging materials themselves remain at least partially translucent. In the German Patent Application DE 100 05 783 A1, different coating materials, natural and/or pseudo-natural dyes, and processes for applying the coating materials, such as, spin coating, spray coating, and doping, are proposed.

### SUMMARY OF THE INVENTION

The goal of the invention is to propose an additional process for producing at least partially translucent packaging materials that contain natural dyes or pseudo-natural dyes, chlorophyll in particular. The goal of the invention with respect to the process, is achieved by adding natural dyes or pseudo-natural dyes to a toner and applying the dyes to the packaging material in a printing step, preferably in an electrophotographic printing machine. The dyes that should preferably be chosen are those mentioned in DE 100 05 783 A1.

Generally, packaging materials are imprinted with information pertaining to the brand and/or the product specifications, for example. If the dye has already been added to the toner before such imprinting occurs, this imprintation step can also beneficially be used to provide better protection for the packaged product from deleterious light.

In a further beneficial development of the process according to the invention, provision is made for the toner to be essentially colorless. The essentially colorless toner that contains the added dyes can then be applied to the entire visible area of the packaging material. Accordingly, the translucency of the packaging material is only slightly limited by the added dye. Beneficially, the entire space that is enclosed by the packaging material is now protected from light with wavelengths that are deleterious, and any product inside the packaging remains easily identifiable for evaluation.

In another beneficial embodiment, provision is made for the colorless toner to be applied to the packaging material through an additional printing unit. This can be accomplished, in particular, in a second printing module, that is located downstream of an initial printing module, that applies a logo, a product name, or the like, to the packaging material.

This printing unit can also be located in the same printing module where other toner images are created on the packaging material. This allows printing units that do not contain any of the natural dyes and/or pseudo-natural dyes in other operational modes simply continue to print without the necessity of changing either the toner or their functions.

From a practical standpoint, it is possible that an additional printing machine could be made available downstream of a printing machine that applies the CMYK colors to packaging materials, so that in tandem operation, the normal imprints can be applied to the packaging material in the CMYK colors and subsequently, a colorless toner containing the desired natural dyes or pseudo-natural dyes can be applied across the full surface with the second printing machine, which for this purpose only one printing unit is needed.

Provision can also be made specifically for the colorless toner to be applied only to the areas of the packaging materials that remain translucent to the undesirable wavelengths after they have been imprinted with the CMYK colors. This would allow colorless toner to be preserved.

A further goal of the subject invention is the development of a toner for use in a process for producing at least partially translucent packaging materials that contain natural dyes and/or pseudo-natural dyes. This goal is achieved through use of a toner to which natural dyes or pseudo-natural dyes, preferably chlorophyll, are added.

For example, the toner used can be a toner containing the same color pigments of one or all of the CMYK colors used in a printing step. This toner can then be used, for example, in a printing step involving imprinting a logo, and/or a product name or the like. Thus, in necessary a printing step, the packaging material's resistance to light can also be increased.

In a further beneficial development of the toner, provision is made for the natural dyes or pseudo-natural dyes that are added to correspond to the properties of the dyes contained in a product to be packaged which are mainly responsible for light absorption.

Beneficially, the toner's natural dye or pseudo-natural dye is not required to be completely identical to the dye contained in the product in order to be packaged. Such dye can be, specifically, a synthetic, pseudo-natural dye with absorption properties that at least essentially correspond to the properties of a natural dye or pseudo-natural dye contained in the product.

In this approach, light of the wavelength that would otherwise be absorbed by the packaged product causing signs of aging, can instead be absorbed by the toner in or on the packaging material.

In a particularly beneficial embodiment, the toner has no color pigmentation. In this case, the basic substance is a colorless toner to which the desired natural dyes and/or pseudo-natural dyes are added. This toner can then be applied to the entire packaging material without adversely affecting its translucent properties beyond that which is necessary.

### BRIEF DESCRIPTION OF THE DRAWINGS

In the detailed description of the preferred embodiment of the invention presented below, reference is made to the accompanying drawings, in which:

FIG. 1 shows a schematic representation of a printing machine that incorporates an additional printing unit; and

FIG. 2 shows a schematic representation of an imprinted packaging material.

### DETAILED DESCRIPTION OF THE INVENTION

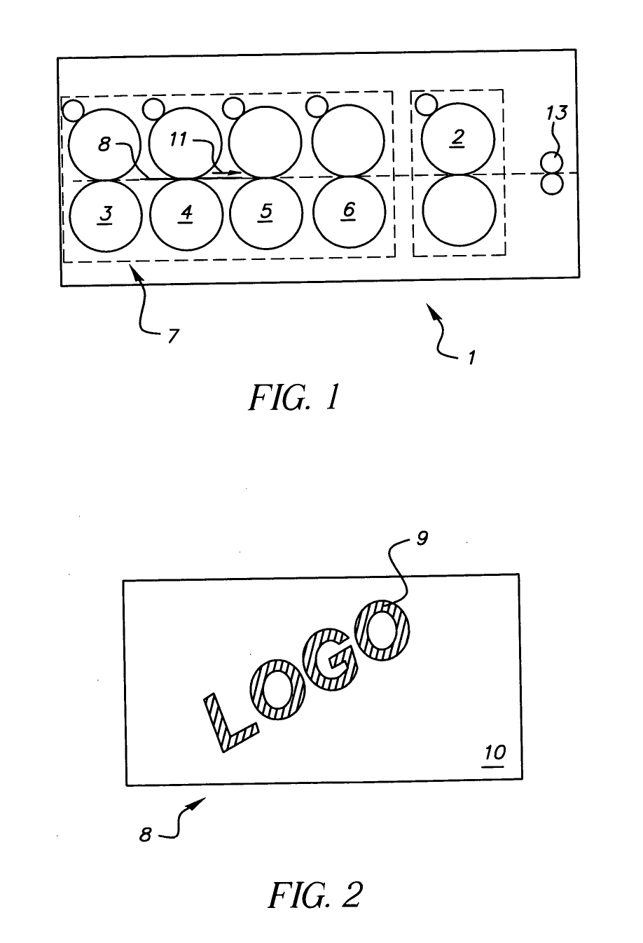

Referring now to the accompanying drawings, FIG. 1 shows a schematic representation of a printing machine 1 that incorporates a printing unit 2 for applying a colorless toner containing natural and/or pseudo-natural dyes. The printing machine incorporates four additional printing units 3 through 6. These printing units 3 through 6 are shown collectively in FIG. 1, in a printing mechanism 7. In this printing mechanism 7, toner images in the CMYK colors are applied to a packaging material 8.

A schematic representation of a packaging material 8 is shown in FIG. 2. The toner images in the CMYK color form a printing format 9 on the packaging material 8. This printing format 9 can be, for example, the name of a product that is to be packaged using the packaging material 8, shown here as LOGO. It is not necessary that this printing format be a continuous unit.

As shown in FIG. 2, an empty area 10 is available on the packaging material 8, on which no printing format 9 has been created by the printing mechanism 7. In the example shown here the printing format 9, is intended to be constructed, so that the packaging material 8, is opaque in the areas that comprise the format.

The remaining area 10 is not covered by the printing format 9. In order to prevent light with undesirable wavelengths from affecting a product that is packaged within the packaging material 8, the area 10 is imprinted in the printing machine with a colorless toner through the printing unit 2. This colorless toner contains the aforementioned natural and/or pseudo-natural dyes. The toner image created by the printing unit 2 is located in the area 10 of the packaging material 8.

In the printing machine 1, the packaging material 8, as is shown in FIG. 1, is conveyed along a travel path in the direction of the arrow 11. The packaging material 8 sequentially passes through the printing mechanism 7, the printing unit 2, and a fuser mechanism 13, by the method in which the toner images in the CMYK colors and the toner image formed by the colorless toner are fused onto the packaging material 8.

The toner images can be fused through the application of heat and pressure, but also through contact-free methods, for example, through continuous or discontinuous irradiation fusing, such as IR fusing, flash fusing, or through passage, through a microwave fuser mechanism. After the toner images have been fused onto the packaging material 8, the entire surface of the packaging material 8 is covered so that light with undesirable wavelengths cannot penetrate the packaging material 8.

Undesirable wavelengths are categorized as such, mainly by the product to be packaged. In the case of vegetable products, the undesirable wavelengths can, for example, be those that are absorbed by chlorophyll.

The dye that is to be added to the colorless toner is selected on the basis of the composition of its wavelengths. Ideally its wavelengths are identical to the dye that is responsible for the light absorption in the product to be packaged. In the example described above that pertains to a vegetable product that is to be packaged, the dye that is added to the colorless toner, for example, is Chorphyllin ERKA Type 111 or Type 100/2 from the Ringe & Kuhlmann Company of Hamburg, Germany.

Potatoes and butter, for example, can be packaged with packaging materials 8 that have been so treated resulting in a process of deterioration that cannot be accelerated by light irradiation. At the same time, however, the product remains identifiable for inspection.

1. A process for producing packaging materials (8) that are at least partially translucent, for use with foodstuffs, cosmetics, and pharmaceuticals, or with other light sensitive products, and packaging materials that contain natural dyes and/or pseudo-natural dyes, characterized by the fact that the natural or pseudo-natural dyes are added to a toner and is applied, preferably in an electrophotographic printing machine (1), to the packaging material (8) in a printing step.

2. A process according to claim 1, characterized by the fact that the toner used as the toner to be applied to the packaging material (8) is an essentially colorless toner.

3. A process according to claim 2, characterized by the fact that the essentially colorless toner is applied to the packaging material (8) by an additional printing unit (2).

4. A toner for use in a process according to claim 1, characterized by natural and/or pseudo-natural dyes added to the toner, contain chlorophyll.

5. A toner according to claim 4, characterized by the fact that the added natural and/or pseudo-natural dyes correspond to the dyes that are essentially responsible for light absorption in the product to be packaged.

6. A toner according to claim 4, characterized by the fact that the toner contains essentially no color particles.
